(19) United States
(12) Patent Application Publication
(10) Pub. No.: US 2020/0011040 A1
(43) Pub. Date: Jan. 9, 2020

(54) Hidden Valve Technology

(71) Applicant: Mark Allen Medearis, Chico, CA (US)

(72) Inventor: Mark Allen Medearis, Chico, CA (US)

(21) Appl. No.: 16/029,158

(22) Filed: Jul. 6, 2018

(51) Int. Cl. E03D 1/32; E03D 1/012; F16K 21/18

(52) U.S. Cl. CPC E03D 1/32; F16K 21/18; E03D 1/012

(57) ABSTRACT

The invention allows the water service from the wall or floor of a building, specifically, the water shut off valve and water supply hose (and all connectors) that provides water to a toilet water holding tank that sits atop the toilet bowl and body, to be hidden in a channel, pocket or other recessed area of the toilet water holding tank. In another embodiment, the channel may proceed at least partially through or even adjacent to the toilet water holding tank and body with a bowl portion.

### CROSS REFERENCE TO RELATED APPLICATIONS

This application claims the benefit of U.S. Provisional Patent Application No. 62/543,520 filed Aug. 10, 2017, entitled “Hidden Valve Technology”, the disclosure of which is incorporated by reference herein in its entirety.

### FIELD OF THE INVENTION

A toilet and water tank designed to conceal the water service valve, water supply hose and connection points to the water tank of a toilet.

### BACKGROUND OF THE INVENTION

Toilets that have a water holding tank that sit atop the toilet bowl and body account for the major percentage in the existing market. Additionally, toilets that have a water holding tank atop the toilet bowl and body have one way to fill the water tank with water—through a hole in the bottom of the water tank! Specifically, the tank is filled with water from the water service from the building structure that the toilet is located in. The water service has an attached water shut-off valve and is connected to the water holding tank using a plastic or metal braided hose or pipe with a first end attachment screw nut and a second end attachment screw nut. The first end screw nut attachment of the hose connects to the water shut-off valve. The second end screw nut attachment connects to a water fill valve in the water holding tank. This attachment requires a hole in the bottom of the water holding tank of current toilets on the market, typically located on the left side of the bottom of the water holding tank. All of these mentioned components are easily in view on the lower left side of the toilet bowl and body. The hose and shut off valve can be unsightly, hard to clean and pose an architectural problem by not allowing enough space for large or tall baseboard or other wall material to be applied without alteration to accommodate the water service connection with water shut-off valve attached. Additionally, the bottom of a water vessel is not the best placement for a hole and can result in leaks with damage to walls and floors as well as water waste.

What is needed is a toilet and water service device that overcomes these shortcomings.

### SUMMARY OF THE INVENTION

The invention comprises a new type of toilet and toilet water holding tank that conceals the water service, hose or pipe, attachments, screw nuts, and shut off valve (sometimes collectively called the “water service” herein).

The preferred embodiment of the invention incorporates a channel in the back of the water holding tank, thereby enabling the water service and shut off valve to be located in the space behind the water tank while allowing a toilet to still be placed closely against a wall or other structure.

Another embodiment of the invention incorporates a channel in the back of the water holding tank and the toilet bowl and body, thereby enabling the water service and shut off valve to be concealed by the toilet bowl and body as well as the water tank in the space. The space can be a pocket, channel, depression or any other space designed to accommodate the water service.

### BRIEF DESCRIPTION OF DRAWINGS

FIG. 1 Top view of a toilet (2) and tank (1) showing the hidden valve channel (3) and the fill valve (8)

FIG. 2 A tank (1) only view showing the hidden valve channel (3) and the fill valve (8)

FIG. 3 Top view of a tank only (1) showing the hidden valve channel (3) and the water fill valve (8)

FIG. 4 A one-piece toilet and tank unit (10) with the hidden valve space (3)

FIG. 5 A back view of the hidden valve channel (3) of the one-piece toilet and tank unit. (10)

### DETAILED DESCRIPTION OF PREFERRED EMBODIMENTS OF THE INVENTION

The object of the invention is to overcome the disadvantages of the existing known technology and provide a hidden valve toilet system.

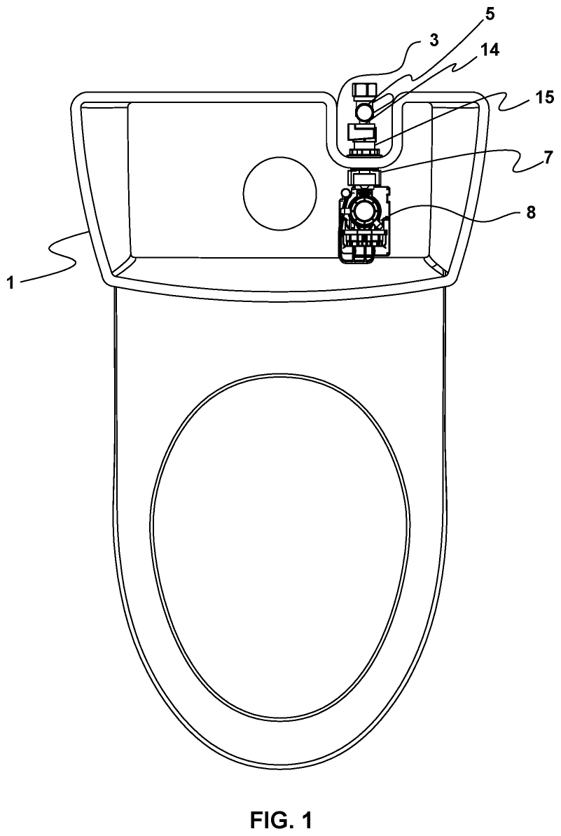

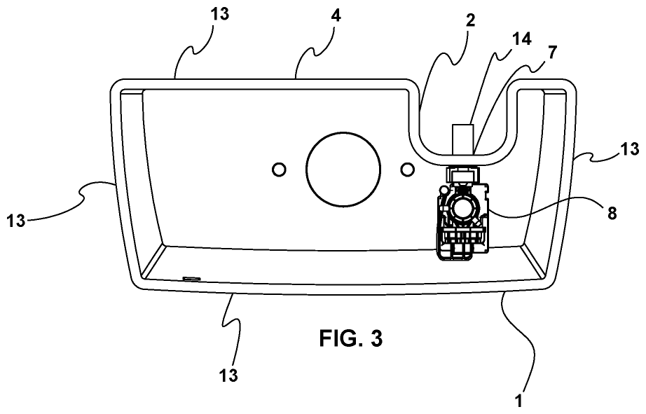

FIG. 1 illustrates a preferred embodiment of the invention comprises a toilet water holding tank (sometimes referred herein as a “toilet tank” or “water holding tank”) (1) that sits atop of the toilet bowl and body and has a space (sometimes referred herein as a “channel”) (3) located in the back portion (4) (reference FIG. 3) of the toilet water tank. (1) The space (3) in the preferred embodiment has a top portion (2) (reference FIG. 3) and a bottom portion. The water shut off valve (5) and supply hose (6), with the first end (14) and second end (15) of the supply hose, are located in the space (3). The water inlet hole (7) designed to accommodate the threadable connection of the supply hose first end (14) and the water fill valve. 8

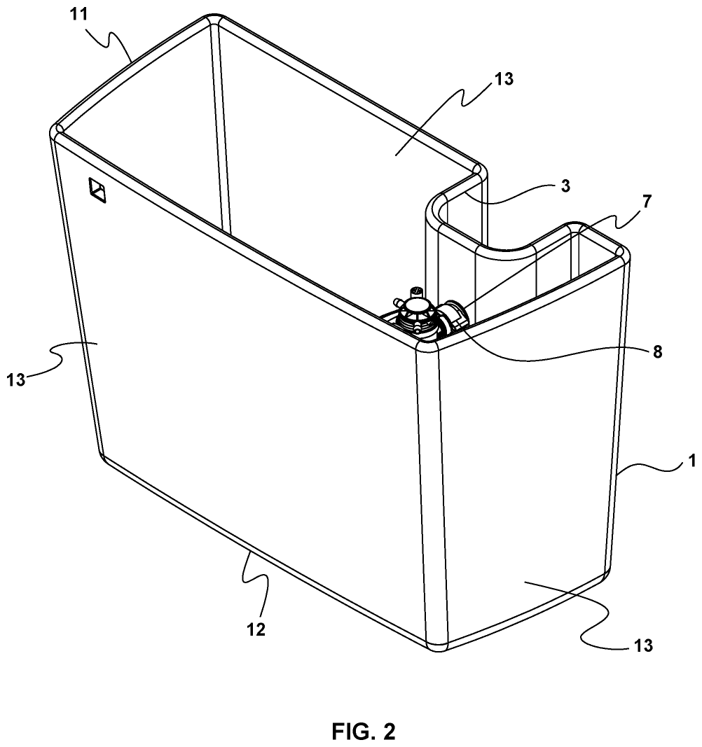

FIG. 2 illustrates the water holding tank (1) is generally a rounded orthotope shape with a top (11), bottom (12), connected by four sides (13). Specifically, the water toilet tank sides comprise a front side portion, two opposing side portions (as a left side and a right side) attached to the front portion, a back portion (4) (reference FIG. 3) opposing said front portion and attached to the opposing side portions, a bottom portion of the tank, and a top portion opposing said bottom portion. The space (3) located in the back portion (4) of the water holding tank (1) is used to house and hide the water service from the building, water shut-off valve (5) and water supply hose (6). In the current toilets and toilet tanks on the market today, the water shut-off valve and water supply hose cannot be hidden. A different view of the water inlet hole (7) and water fill valve (8) are seen in this illustration.

Now turning to FIG. 3, and in the preferred embodiment, wherein the water service of a building-structure, water service pipe (6), and the water shut off valve (5) connected to the water service pipe (6) are positioned on the wall behind the toilet such that the toilet tank (1) may be placed in front of the water service pipe, water service or hose (6) and the shut-off valve. 5 Thereby, the water service and attachments are located in the back portion (4), one of the four sides of the tank. (13) As in conventional toilets, a water supply hose (6) with a first end (14) and a second end (15) connects the toilet to the water shut off valve (5) of the water service pipe which proceeds from the wall of a building. The water supply hose first end (14) is threadably connected to the water shut-off valve (5) by a watertight screw nut and the water supply hose second end (15) is threadably connected to a water fill valve (8) in the toilet tank (1) by a watertight screw nut through the water inlet hole (7) in the top portion. (2) These watertight screw nuts may be replaced with some other threadable attachment or non-threadable attachment. Other structures may be present in the hose or pipe assembly, including other hoses, pipes and tubes of various shapes and materials, such as an elbow joint to enable a satisfactory connection configuration (sometimes this water service configuration is simply called “water service” herein instead of listing pipes, valves, screw nuts, and other pieces that may be used to deliver water to the toilet). In the preferred embodiment, the toilet water tank (1) has a space in the configuration of a channel (3) on the back side (4) of the toilet tank (the side usually facing a wall) large enough to accommodate the water supply, shutoff valve (5) and hose. 6 The water supply hose (6) second end threadably attaches to the water fill valve via the water inlet hole (7) on the back portion (4) of the tank located, preferably near the top portion (9) of the top of the channel (3), where the fill valve water inlet hole passes through the water holding tank above the water fill-level of the water holding tank (above the meniscus of the water line when the toilet water tank reaches a predetermined volume of water) with at least one screw nut or other threaded coupling connecting the water supply hose (6) to the toilet tank fill valve. 8 The water supply hose (6) supplies water to the water fill valve (8) inside the water tank. 1

The invention thereby eliminates the hole typically found in the bottom of current-day toilet water tanks, thereby eliminating a potential leak area which could cause water waste and water damage to a building structure.

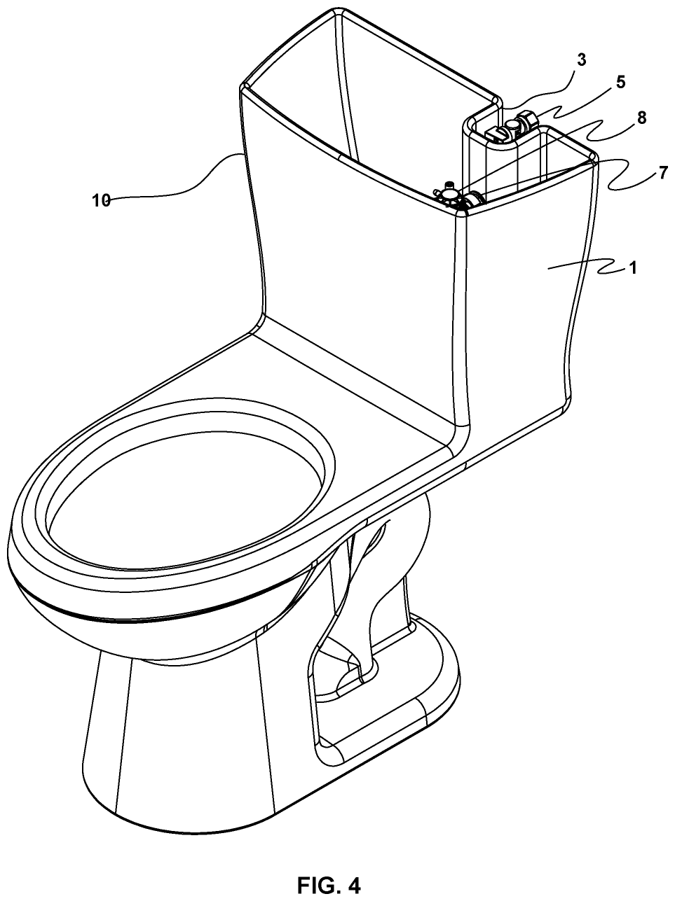

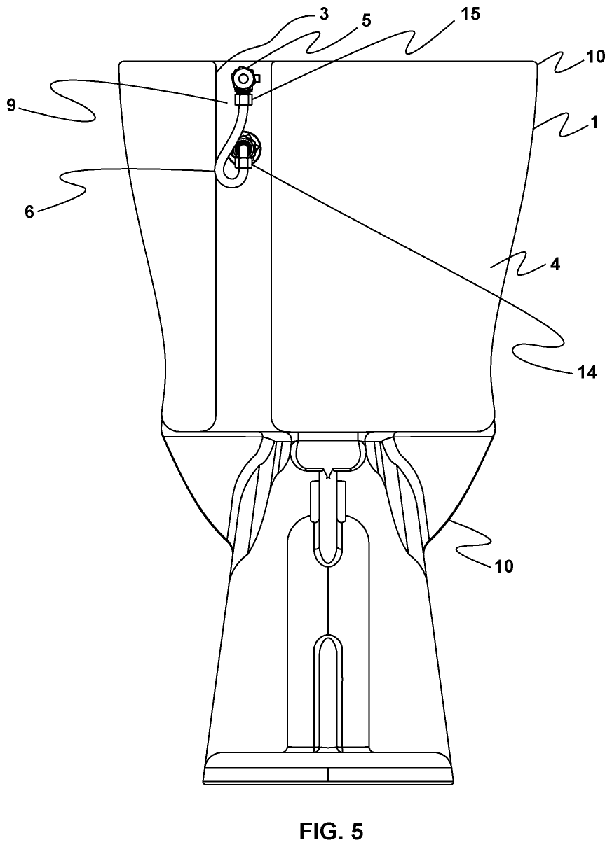

Now turning to FIGS. 4 and 5, and in yet another embodiment, in the case of a one-piece toilet unit, the bowl and body and tank (1) are molded as one single unit, (10) the space in the configuration of a channel (3) is incorporated into the bowl and body of the toilet as well as the back portion (4) of the water holding tank. 10 Specifically, the toilet water holding tank with four side portions (13) comprising a front portion, two opposing side portions, a back portion (4) opposing said front portion, a bottom portion, and a top portion (9) opposing said bottom portion, is configured with a toilet body with a bowl portion. The toilet body is positioned below the toilet water holding tank, and connected to the toilet water holding tank, such that the toilet body and the toilet water holding tank are configured to convey water from the toilet water holding tank to the toilet bowl portion. The channel (3) is incorporated into both the toilet body and said toilet water holding tank with a water inlet hole (7) positioned on the back portion of the water holding tank. The preferred position of the water inlet hole is above the water fill level of said toilet water holding tank. The channel is adapted to incorporate a water supply hose (6) with a first end (14) and a second end (15) as well as a water shut off valve (5). The water fill valve position is found at (8). The channel may proceed either completely through, partially through or at least partially adjacent to the toilet body and toilet water holding tank. Naturally, the channel is designed to incorporate the water supply hose, the shut off valve, and any needed attachments to connect the water supply hose to the water service as well as the water inlet valve, whether the attachments use threadable connectors or some other type of connection devices.

In another embodiment, the channel (3) proceeds completely through the body of the toilet. In still yet another embodiment, the channel (3) proceeds only partially through the body of the toilet. In another embodiment, the channel (3) proceeds adjacent to the body of the toilet. In another embodiment, the channel (3) proceeds completely through the body and bowl portion of the toilet. In still yet another embodiment, the channel (3) proceeds only partially through the body and bowl portion of the toilet. In another embodiment, the channel (3) proceeds adjacent to the body and bowl portion of the toilet. The space, preferably a channel, may be a pocket or other shape designed to accommodate the water service and attachments thereto aforementioned.

Upon reading this disclosure, those of skill in the art will appreciate still additional alternative structural and function designs for a quad dimensionally flexible battery. For example, shapes and orientations of the individual battery cells are not limited to squares, circles, cubes, hexagons, octagons or any other shape. Thus, while particular embodiments and applications have been illustrated and described, it is to be understood that the disclosed embodiments are not limited to the precise construction and components disclosed herein. Thus, while particular embodiments and applications have been illustrated and described, it is to be understood that the disclosed embodiments are not limited to the precise construction and components disclosed herein. Additionally, variants of additional embodiments are possible. Therefore, the spirit and scope of the appended claims and the concepts taught herein should not be limited to the description of the preferred embodiments and embodiments contained herein.

1-20. (canceled)

21. A toilet water holding tank which sits atop a toilet having a toilet body which includes a toilet bowl, comprising:
a toilet tank having a front wall, a back wall and respective side walls, the tank having a rounded orthotope shape in which water is introduced into the tank through a water inlet opening formed in the tank and discharged from the tank through a water outlet in a base of the tank; and,
a u-shaped recess formed in the back wall of the tank intermediate the width of the back wall and not adjacent either side wall of the tank, the recess having a base wall extending parallel to the back wall of the tank and opposed side walls extending parallel to the respective side walls of the tank, the recess extending the height of the tank so as to form a channel in the back wall of the tank, the size and shape of the channel being such that a water service for the toilet fits substantially within the recess and is concealed from view so as to improve the aesthetic appearance of the toilet while accommodating a water service connection to the toilet, wherein said water inlet opening is formed in the channel in the base wall of the recess at a height above that of the water outlet.

22. The toilet water holding tank of claim 21 wherein the width of the channel is uniform throughout the height of the tank.

23. (canceled)

24. (canceled)

25. The toilet water holding tank of claim 21 in which the water service includes a water fill valve and a water shut-off valve, the water fill valve being installed within the tank, the shut-off valve being installed in the recess formed by the channel and completely fitting within the channel, an inlet to the shut-off valve being connected to a source of water, and an outlet of the shut-off valve being connected to an inlet of the water fill valve through the water inlet opening formed in the channel.
